(19) United States
(12) Patent Application Publication
(10) Pub. No.: US 2024/0429367 A1
(43) Pub. Date: Dec. 26, 2024

(54) BIPOLAR BATTERY WITH PROTON AND HYDROXIDE ION CONDUCTING POLYMER BASED SEPARATOR

(71) Applicant: KAWASAKI MOTORS, LTD., Hyogo (JP)

(72) Inventors: Kwohsiung YOUNG, Hyogo (JP); Taihei OUCHI, Hyogo (JP); Hiroshi FUKUNAGA, Hyogo (JP)

(73) Assignee: KAWASAKI MOTORS, LTD., Hyogo (JP)

(21) Appl. No.: 18/559,965

(22) PCT Filed: May 13, 2021
(86) PCT No.: PCT/JP2021/018281

§ 371 Date: Nov. 9, 2023

(51) Int. Cl. H01M 4/24; H01M 4/32; H01M 4/38; H01M 4/50; H01M 4/52; H01M 10/28; H01M 10/34; H01M 50/426; H01M 50/431; H01M 50/449; H01M 50/491

(52) U.S. Cl. CPC H01M 4/242; H01M 4/32; H01M 4/383; H01M 4/50; H01M 4/52; H01M 10/282; H01M 10/347; H01M 50/426; H01M 50/431; H01M 50/449; H01M 50/491; H01M 2300/0065

(57) ABSTRACT

Provided are bipolar batteries that include a stacked plurality of cells. Two or more of the cells include a cathode, an anode, a proton or hydroxide ion conducting polymer separator between the cathode and said anode, wherein in some aspects the separator includes or alone acts as a proton or hydroxide conducting electrolyte, and a bipolar metallic plate associated with the anode or the cathode. The cells optionally include and electrolyte that includes a polymer capable of conducting a proton or a hydroxide ion. The separator may in the form of a film and is optionally not bonded to either the anode or the cathode, or may be in the form of a coating on the anode, the cathode, or any combination thereof.

### TECHNICAL FIELD

This disclosure relates to batteries, more specifically secondary batteries that cycle protons or hydroxide ions between the anode and the cathode in the generation of an electrical current that may be used to power one or more devices.

### BACKGROUND ART

A universal need in the field of energy storage is increased power density. With ever increasing demands on size, weight, and the ability to deliver large amounts of energy when desired, new battery designs are needed. Bipolar batteries provide advantages over other battery designs that help address these needs. Bipolar batteries have improved scalability, relatively high energy density, high power density and design flexibility.

Bipolar batteries are generally characterized by the presence of a bipolar plate formed of a substrate with a cathodic material on one surface and on the opposite side is an anodic material. These plates may be arranged in a stack such that the anodic material is effectively paired with a cathodic material on a separate bipolar plate with a separator and electrolyte between the two to allow the formation of individual cells that can effectively be used in energy storage or production. The electrolyte and separator allow for ion flow between the anodic material and the cathodic material. In a bipolar battery, the electrolyte in each individual cell is isolated from each other to prevent shortage of the cell.

Bipolar batteries cycle ions such as protons or hydroxide ions, however, the traditional alkaline electrolytes require unique enclosure designs because is difficult to separate the electrolyte between adjacent cells in a bipolar battery design. Placing all the elements in a single enclosure, which is highly desired so as to provide a compact battery design, requires complex gasket mechanisms to prevent leaking of electrolyte between cells in the stack and prevent subsequent shorts from forming. Alternative designs where the electrolyte is separated into individual cells helps address issues with potential shorts, but these suffer from increased cell size thereby detracting from the overall compact design that is desired in the industry.

As will be explained herein below, the present disclosure addresses these needs by providing new bipolar cell designs with particular separator and/or electrolyte arrangements and materials that effectively isolate electrolyte while at the same time not requiring bulky or complex cell design. These and other advantages of the disclosure will be apparent from the drawings, discussion, and description which follow.

### SUMMARY

The following summary is provided to facilitate an understanding of some of the innovative features unique to the present disclosure and is not intended to be a full description. A full appreciation of the various aspects of the disclosure can be gained by taking the entire specification, claims, drawings, and abstract as a whole. The inventions as described herein are presented in the claims that follow.

Proton or hydroxide ion conducting batteries have numerous advantages including fast ion conduction, high energy density, relatively low cost and improved safety profiles relative to lithium ion batteries. Finding ways to effectively incorporate these cell types into a biopolar battery design has historically proven difficult. This disclosure provides new designs and materials for efficient and compact bipolar batteries.

As such, provided are bipolar batteries that include two or more cells, at least one of which includes a cathode active material, an anode active material, a proton or hydroxide ion conducting polymer separator between the cathode active material and the anode active material, and a bipolar metallic plate associated with the anode active material or the cathode active material. The battery may, but need not necessarily include an electrolyte including a solid polymer capable of conducting a proton or hydroxide ion. The cell can be in several possible configurations. Optionally, the bipolar metallic plate is associated with the cathode active material and the anode active material. In some aspects, the separator is in the form of a film, said film not bonded to either an anode active material or a cathode active material. Optionally, the separator is in the form of a coating on the anode active material, the cathode active material, or both. In some aspects, the cathode active material is pasted on a cathode substrate, said anode active material is pasted on an anode substrate, or both such that the cathode, anode or both are able to be independently assembled in the battery stack without being coated onto another surface or material.

A separator as provided herein conducts, optionally selectively conducts a cation or an anion, illustratively a hydroxide ion. The ion conducting polymer that may make up the separator may be a hydroxide ion conducting membrane, optionally wherein said hydroxide conducting membrane comprises a support polymer coupled to an amine. Alternatively, a separator may be a proton conducting membrane, optionally wherein the proton conducting membrane includes a perfluorinated polymer, optionally a perfluorosulfonic acid (PFSA) polymer. The ion conducting polymer of the separator may be coated on, impregnated within or other configuration, an ion conducting substrate, wherein the ion conducting polymer optionally includes a perfluorinated polymer, optionally a perfluorosulfonic acid (PFSA) polymer. In some aspects, the ion conducting substrate includes Pt, Pd, LaNi₅, or an oxide optionally ZrO₂ or a perovskite oxide, or combinations thereof. In any of the configurations of the foregoing in this section, the separator further includes one or more ion conducting organic powders.

The resulting batteries according to any of the forgoing optionally has a coulombic efficiency of 70% or greater demonstrating high efficiency nature of the batteries as provided according to this disclosure.

### BRIEF DESCRIPTION OF DRAWINGS

FIG. 1 illustrates exemplary configurations of a bipolar battery according to some aspects as provided herein;

FIG. 2 illustrates various arrangements for a separator as provided herein;

FIG. 3 illustrates various arrangements of a separator relative to anode active materials and cathode active materials as provided herein;

FIG. 4 is a plot of the charge/discharge profile of selected cycles of an exemplary bipolar battery with 5 cells according to some aspects of this disclosure; and

FIG. 5 is a plot of the charge/discharge profile of selected cycles of an exemplary bipolar battery with 2 cells according to some aspects of this disclosure.

### DETAILED DESCRIPTION OF VARIOUS ASPECTS

Provided are bipolar batteries that address the needs for compact bipolar cell design, but that may be used for proton or hydroxide ion conducting cell systems. The batteries include one or more separators that are able to selectively conduct a proton or hydroxide ion, but that optionally provide electrical isolation between the anode active material and matched cathode active material so as to prevent shorts and early discharge of the battery during storage.

The present disclosure utilizes ion conducting polymer separators that may selectively be capable of transporting a proton or a hydroxide ion, depending on the type of anode and cathode active materials used in the system. The use of selective ion conducting polymers allows for the formation of materials that include little to no liquid electrolyte, relative to traditional alkaline cells, thereby negating the need for complex bipolar cell designs yet maintaining compact construction.

The new generation of proton conducting batteries operate by cycling hydrogen between the anode and the cathode. The anodes thereby form a hydride of one or more elements in the anode during charge. This hydride is formed reversibly such that during discharge the hydride becomes the elemental portion of the anode active material generating both a proton and an electron. The half reaction that takes place at the anode can be described per the following half reaction:

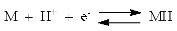

where M as provided herein is or includes one or more transition or post-transition metals.

The corresponding cathode reaction half reaction is typically:

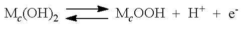

wherein Me is any suitable metal(s) for use in a cathode electrochemically active material, optionally Ni.

In contrast to proton conducting batteries other battery chemistries utilize a hydroxide ion as the charge conductor between the anode and the cathode. These require electrolytes and separators that are capable of conducting an anion such as a hydroxide ion. The half reactions of hydroxide ion conducting batteries are as follows:

M(s)+2OH⁻(aq)→MO(s)+H₂O(l)+2e⁻

2MO₂(s)+H₂O(l)+2e⁻→M₂O₃(s)+2OH⁻(aq).

The batteries of this disclosure capitalize on these cell chemistries, but are able to employ them in a compact and energy dense bipolar cell configuration.

As used herein, the term “battery” means a collection of two or more cells in series as configured in a bipolar battery. A “cell” cell includes a cathode active material, anode active material and a separator as provided herein and functions to reversibly store energy electrochemically.

As used herein, the term “selective” in the sense of ion transport is defined as the element (e.g. separator, electrolyte, or combination thereof) is capable of transporting a single ion type with greater efficiency relative to other ion types. As an example, an anion-selective media will preferentially transport an anion relative to a cation, and optionally relative to other anions. A cation-selective media will preferentially transport a cation relative to an anion, and optionally relative to other cations.

As used herein, an “anode” includes an electrochemically active material that acts as an electron acceptor during charge.

As used herein, a “cathode” includes an electrochemically active material that acts as an electron donor during charge.

When atomic percentages (at %) are presented and not otherwise defined, the atomic percentages are presented on the basis of the amount of all elements in the described material other than hydrogen and oxygen.

The present disclosure provides bipolar batteries that employ solid ion conducting polymer materials that may function as a separator alone or as both a separator and electrolyte material. The separators conduct, optionally selectively conduct, either a proton or a hydroxide ion as the charge carrier between the anode and the cathode in each individual cell in the bipolar battery. The separator may be in one or more of several desirable configurations such as a film of ion conducting polymer, porous film housing an ion conductive polymer, an ion conducting polymer pasted on a porous substrate housing the same or a different ion conducting polymer, or other desirable configuration. In any desired configuration, the separator may further include one or more ion conducing inorganic powders housed within one or more regions of the separator material, optionally within the ion conducting polymer. These separator configurations, optionally in conjunction with an anode, cathode or both that include a substrate therein or thereon that is distinguishable from a bipolar plate, allow for the formation of bipolar batteries that have excellent power density and do not require complex design configurations to maintain electrolyte in any one region of the cell(s).

As such, bipolar batteries are provided that include two or more cells, wherein at least one of the cells includes a cathode active material, an anode active material, a proton or hydroxide ion conducting polymer separator between the cathode active material and the anode active material, and a bipolar metallic plate associated with the anode active material or the cathode active material. The bipolar metallic plate is optionally coated on a first side with an anode active material and a second side with a cathode active material. Thus, the bipolar battery includes at least two of the above cells in a configuration sandwiched between two current collectors that serve as intermediate or ends of the bipolar cell stack. It is appreciated that when only two of such cells are present, there may be a single bipolar metallic plate shared between the two cells. In some aspects, a bipolar battery separator is used without further electrolyte material as the separator material itself may serve to conduct the desired ion between the cathode active material and the anode active material. In other aspects, bipolar battery as provided herein includes an electrolyte that may be a solid polymer electrolyte, a liquid electrolyte, or any combination thereof where the electrolyte may be housed entirely within the separator, or may be adjacent the separator on one or both sides between the separator and the anode active material and/or the cathode active material.

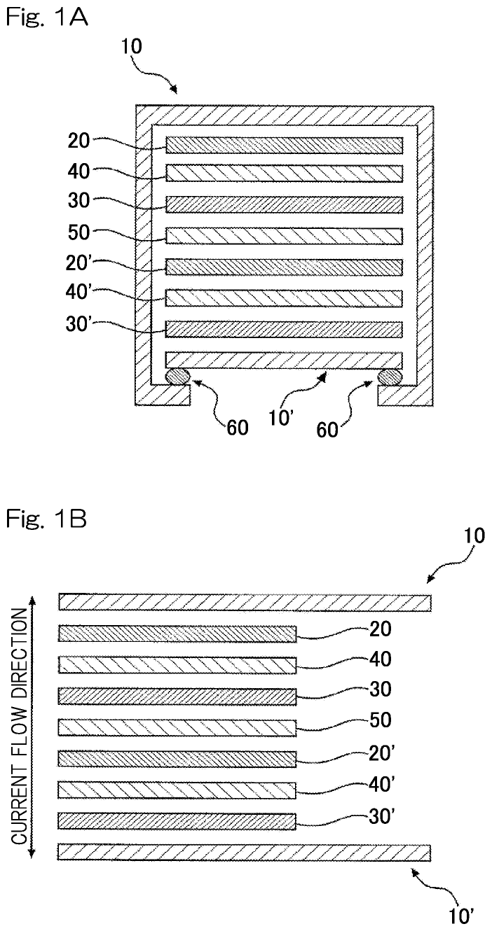

An illustrative example of a bipolar battery as provided herein according to some aspects is illustrated in FIG. 1. It is noted that FIG. 1 is presented for illustrative purposes only and not a limitation of the structure of a bipolar battery. The bipolar battery includes a current collector 10, 10′ positioned at both ends of the stack. On the cell side of the current collector is an active material such as a cathode active material 20, 20′ or an anode active material 30, 30′. Adjacent the active material is an ion conducting polymer separator 40, 40′. Separating the two cells is a bipolar plate, optionally a bipolar metallic plate 50. The bipolar plate may be shared between the two cells of the battery or two such bipolar plates may be placed in electrical connection with each other but serve to otherwise separate the two cells. In particular aspects, a bipolar plate is shared between adjacent cells of the battery. Optionally, one of the two current collectors 10, 10′ is a portion of or serves as a housing for a battery. In such a configuration, a gasket or O-ring 60 may be housed between the two current collectors that may serve to isolate the battery from the external environment, but also serves as an insulator between the two current collectors to prevent shorting of the bipolar battery.

A bipolar battery as provided herein includes a proton or hydroxide ion conducting polymer separator. In some aspects, a separator may be in the form of an ion conducting film. An ion conducting film may be of sufficient film characteristics (e.g. rigidity) to be layered upon or between an anode active material and a cathode active material and provide a suitable thickness to physically separate the anode active material from the cathode active material. The separator in these aspects may be fully formed prior to cell assembly and simply layered with the other elements of the cell in formation thereof.

In other aspects, a separator may be formed as a coating in contact with an anode active material, a cathode active material, or both. For example, an electrode (anode or cathode) may be formed upon which a separator material may be coated thereon either following, during or prior to polymerization of the polymer material so as to form a direct coating on the desired anode, cathode or both. In some aspects, a coating optionally encases the electrode active material upon which it is coated such that the electrode active material is in contact with the current collector substrate, any supporting substrate and the separator material alone.

A separator includes one or more ion conducting polymers. An ion conducting polymer is optionally any material that may be by nature of the material conductive or selectively conductive to a proton or a hydroxide ion or may be subsequently modified to as to be able to conduct, optionally selectively conduct, a proton or hydroxide ion. The separators are located between the anode and the cathode in each of the cells. In some aspects, the separator may have a surface area that is greater than the area of the adjacent cathode and anode. The separator may completely separate the cathode active material from the anode active material in each cell. The edges of the separator may contact peripheral edges of the bipolar plate or current collector plates where the plates do not have an anode active material or cathode active material disposed thereupon so as to completely separate the anode active material from the cathode active material. The separator functions to prevent short circuiting of the cells due to dendrite formation; functions to allow liquid electrolyte if present, ions, electrons or any combination of these elements to pass through it, optionally selectively pass through or be conducted by the separator. The separator may be prepared from a non-electrically conductive material, such as polymer films optionally porous polymer films, glass mats, porous rubbers, ionically conductive gels or natural materials, and the like. Among exemplary materials useful as separators are porous or non-porous high or ultra-high molecular weight polyolefin materials that serve as a base or as the ion conductive polymer in the separator.

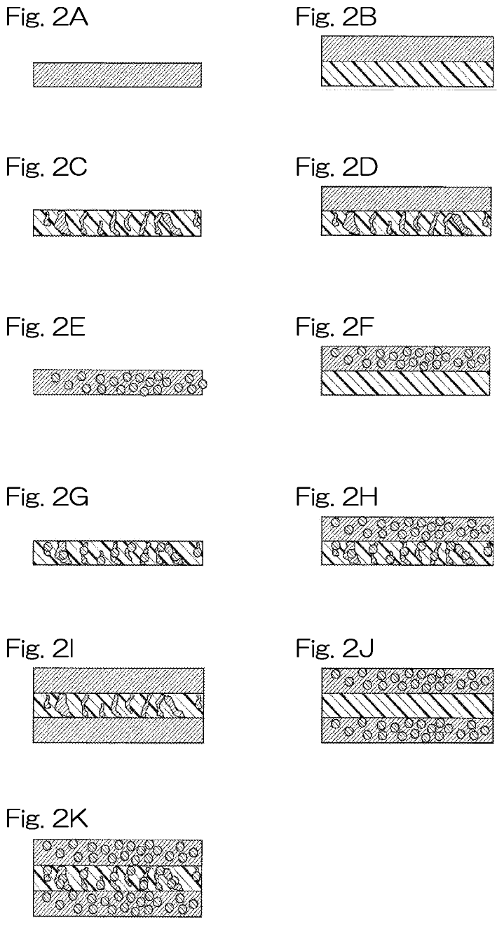

The separator be in the form of an ion conducting polymer (ICP) membrane that may serve as a standalone system for the transfer of ions between a cathode and anode of a cell is optionally as illustrated in FIG. 2A. Alternatively, an ICP membrane may be associated with an ion conducting solid support, optionally as illustrated in FIG. 2B, whereby the term “solid” with respect to a support as provided herein means that the support will not transmit ICP through the support during operation of the cell. The ICP may be layered on, coated on or otherwise placed in direct contact with a support to form the overall separator.

In some aspects, a separator may be formed of a porous substrate that contains pores or tortuous paths through the separator that allows electrolyte, ions, electrons or a combination thereof to pass through the separator, optionally as illustrated in FIGS. 2C and D. The pores of the substrate may be filled with one or more ICPs to form the resulting separator. Such highly porous substrate materials may be made from known porous ceramic or polymer materials. The ICP may be housed within the pores so as to form a conductive path for ions to flow or be conducted through the separator material. In some aspects, a porous separator material is further coated on one or both sides with a sheet or film of ICP in formation of the separator as a whole optionally as illustrated in FIGS. 2D-I. Optionally, an ICP may be coated on an electrically insulating material such as polypropylene that serves as a structural aspect of a separator.

A porous substrate optionally has a porosity defined as the ratio of pore volume (i.e. void volume) to total volume of the porous substrate and may be measured by any of known methods in the art, illustratively mercury intrusion, gas adsorption, or a capillary flow method based on fluid flow through the membrane such as achieved by a capillary flow porometer. A porosity is optionally equal to or greater than 20%, optionally 30%, optionally 40%, optionally 50%, optionally 60%, optionally 70%, optionally 80%. In some aspects, a porosity is at or between 20% and 80%, optionally 30% and 60%, optionally 40% and 50%.

A separator as provided herein is or includes an ion conducting polymer. Illustrative examples of ion conducting polymers include those that conduct, optionally selectively conduct, a proton or hydroxide ion, yet are electrically insulating. An electrical resistivity of a separator used in a cell as provided herein is at or less than 1×10⁻⁴ ohm·m², optionally 8×10⁻⁵ ohm·m² or less, optionally 6×10⁻⁵ ohm·m² or less, optionally 4×10⁻⁵ ohm·m² or less, optionally 3×10⁻⁵ ohm·m² or less.

A proton conducting material suitable for use as an ICP in a separator include but are not limited to hydrated acidic polymers that may include interpenetrating hydrophobic and hydrophilic domains where the hydrophobic domains may provide the structural dimension of the polymer whereas the hydrophilic domains allow for selective proton conduction. Illustrative examples of such polymers include those formed of poly(styrenesulfonate). Other illustrative examples of proton conducting materials include perfluorinated polymers such as but not limited to perfluorosulfonic acid (PFSA) polymers such as NAFFION. In some aspects, a polymer is a polyaromatic polymer that is electrically insulating but conductive of protons. In yet further aspects, a proton conducting polymer is a composite material where proton conducting materials are embedded within or adhered to a polymer matrix that is optionally non-proton conducting.

A proton conducting polymer optionally is electrically insulating but conductive of protons. Proton conductivity is optionally at or greater than 0.1 mS/cm when measured at room temperature, optionally 0.2 mS/cm or greater, optionally 1 mS/cm or greater.

In other aspects an ion conducting polymer is a hydroxide ion conducting polymer such as an anion exchange membrane (AEM) or polymer. Anion exchange membranes or polymers (AEP) are generally based on a polymeric material linked to or including one or more cationic groups that serve to allow conduction of anions through the membrane material. The membranes or polymers may include a polyolefin that is linked to or embedded with an anion exchange material to allow selective conduction of anions. Other examples include direct anion exchange polymers themselves that may coat or be embedded into a membrane and/or may coat one or more electrodes. Optionally, an AEM is or includes a cationic group attached to a polymeric material. Such cationic groups may include quaternary ammonium or imidazolium groups. Other examples include those based on guanidinium, DABCO, benzimidazolium, pyrrolidinium, sulfonium, phosphonium, and ruthenium-based cations. Other illustrative examples of an anion exchange membrane may be found in international patent application publication number WO 2015/015513.

In some examples, an AEM or AEP is or includes those based on modified benzimidazolium such as poly [2,2′-(2,2″,4,4″,6,6″-hexamethyl-p-terphenyl-3,3″-diyl)-5,5′-bibenzimidazole] (HMT-PBI) or its methylated form HMT-PMBI. Other examples include Poly [2,2′-(m-mesitylene)-5,5 ‘-bis(N,N’-dimethylbenzimidazolium)] (Mes-PDMBI, 2-X—) and poly [2,2′-(m-phenylene)-5,5′-bis(N,N′-dimethylbenzimidazolium)] (PDMBI, 3-X—). Such materials are commercially available from IONOMR, Vancouver, CA.

Such anion exchange polymers are optionally in the form of a sheet of film. In other aspects, an anion exchange polymer is bound to, coated onto, or impregnated into, or combination thereof, a polyolefin material. Illustrative polyolefin materials suitable for an anion exchange membrane, a proton exchange membrane, or both include porous or non-porous high or ultra-high molecular weight polyolefin materials that serve as a base or as the ion conductive polymer in the separator. Illustrative materials include those based on or of poly(arylene ether) s, poly(biphenyl alkylene) s, and polystyrene block copolymers. Optionally, a polymer backbone is or includes a polysulfone, poly(p-phenylene oxide) (PPO), poly(p-phenylene ether) (PPE), polybutylene, poly(butyl acrylate), styrene-ethylene-butylene-styrene, polypropylene, polyethyelene, polyvinylidene fluoride or polyvinylidene difluoride (PVDF), among others.

An anion conducting polymer optionally is electrically insulating but conductive of hydroxide ions. Hydroxide ion conductivity is optionally at or greater than 0.1 mS/cm when measured at room temperature, optionally 0.2 mS/cm or greater, optionally 1 mS/cm or greater, optionally 2 mS/cm or greater, optionally 3 mS/cm or greater, optionally 5 mS/cm or greater, optionally 10 mS/cm or greater, optionally 13 mS/cm or greater, optionally 15 mS/cm or greater.

A separator as provided herein may include one or more ion conducting inorganic powders (ICIP) that are embedded in the ion exchange membrane as a standalone membrane, as a coating on a substrate, as impregnated within the pores of a porous substrate or any combination thereof, optionally as illustrated in FIG. 2E-K. Illustrative examples of ICIP include untreated perovskite oxides and processed perovskite oxides. Perovskite-type oxides are the materials having a general formula ABO₃ with larger A cation coordinated to 12 anions and B cation occupying six coordinate sites, forming a network of corner sharing BO, octahedra. The A cations may be rare-earth, alkali or alkaline earth elements. Typically, the B elements are one or more transition metals. In some aspects, A may be Ca, Sr, La, Na, K, Mg, or combinations thereof. Optionally, B may be Al, Ti, Nb, Ta, Ga, or combinations thereof. More specific examples include, but are not limited to substituted or unsubstituted NaNb_{0.5}Al_{0.5}O_{2.5}, KNb_{0.5}Al_{0.5}O_{2.5}, Ba₂NaMoO_{5.5}, Ba₂LiMoO_{5.5}, Ba₂NaWO_{5.5}, CaTi_{0.95} Mg_{0.05}O_{3-δ}, Nd_{0.9}Ca_{0.1}AlO_{3-δ}, La_{0.9}Sr_{0.1}Ga_{0.8}Mg_{0.2}O_{2.85}, Ba₂In₂O₅, Ba₃In₂ZrO₈, Bi₄V₂O₁₁, Bi₄V_{1.8}Cu_{0.2}O_{11-δ}, La_{0.8}Sr_{0.2}Ga_{0.83}Mg_{0.17}O_{2.815}, BaCeO₃, Ba₂SnYO_{5.5}, BaTbO₃, BaZrO₃, SrCeO₃, Ba₃CaNb₂O₉, LaScO₃, CaZrO₃, Gd₂O₃, SrTiO₃, La₂Zr₂O₇, CaSrO₃, Nd₂O₃, SrZrO₃, Er₂O₃, LaPO₄, and LaErO₃, among others. A processed perovskite oxide may be a product of chemically modified perovskite oxide through certain process.

A separator may include one or more ion conducting polymers, ion conducting inorganic powders, or both on or impregnated within (or both) an ion conducting substrate. Illustrative examples of ion conducting substrates include those formed of one or more transition metals, or oxides, hydroxides, or oxyhydroxides thereof. Illustrative examples include but are not limited to Pt, Pd, LaNi₅. Alternatively or in addition, an ion conducting substrate for use in a separator may include an oxide such as a metal oxide (e.g. ZrO₂, CeO₂, TiO₂) or perovskite oxide as otherwise described herein.

A separator may be provided in the form of a membrane or a film and simply stacked between the anode active material and cathode active material, or may be coated onto an anode active material, cathode active material or both. Forming an ion conducting polymer separator may be achieved by general polymerization methods as known in the art, illustratively free radical polymerization, from the desired precursor materials. An ion conducting polymer layer may optionally be coated onto a desired electrode surface such as by polymerizing the material on the surface of the desired electrode. The precursor materials may combined with a solvent and coated onto the electrode material. The solvent that is used for the polymerization reaction of the polymer is not particularly limited. Illustratively, a solvent may be hydrocarbon-based solvents (methanol, ethanol, isopropyl alcohol, toluene, heptane, and xylene), ester-based solvents (ethyl acetate and propylene glycol monomethyl ether acetate), ether-based solvents (tetrahydrofuran, dioxane, and 1,2-diethoxyethane), ketone-based solvents (acetone, methyl ethyl ketone, and cyclohexanone), nitrile-based solvents (acetonitrile, propionitrile, butyronitrile, and isobutyronitrile), halogen-based solvents (dichloromethane and chloroform), and the like. As an example, one or more ion conducting polymer separator precursor materials may be combined with a solvent on the surface of an electrode, optionally retained by a structure of the electrode itself, a container in which the electrode is placed into or other retention system, and the precursor materials allowed to dry or polymerize on the surface of the electrode to thereby form a layer thereon at the desired size and thickness.

A separator as provided herein has a thickness. A thickness should be sufficient so that the desired electrical resistance is achieved as well as physical separation of the anode from the cathode, but also not so thick that efficient transport of the desired ion through the separator is undesirably inhibited. Illustratively, a separator has thickness of 1 micron to 100 microns or more. Optionally, a separator thickness is 1 micron to 50 microns, optionally 10 micron to 30 microns, optionally 20 microns to 30 microns.

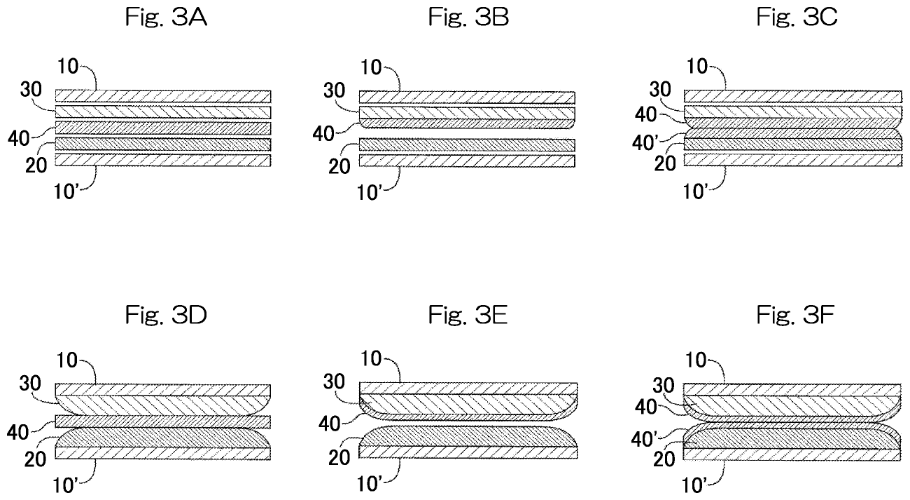

As eluded to above, a separator as provided herein may be in the form of a film, membrane or may be coated onto one or more other components of a cell, or combinations thereof. FIG. 3 illustrates exemplary arrangements of a separator with respect to other elements in a cell of a bipolar cell. In some aspects as illustrated in FIG. 3A, a cell of a bipolar battery includes a bipolar metallic plate 10 electrically associated with an anode active material 30, the anode active material separated from a cathode active material 20 by a separator 40 as provided herein. The cathode active material may be electrically associated with a current collector or a second bipolar metal plate as illustrated in FIG. 3. FIG. 3A illustrates an arrangement whereby an anode active material, cathode active material and separator are each in the form of independent films or membranes so as to be individually stackable in the desired arrangement to form the bipolar battery.

In other exemplary aspects as illustrated in FIG. 3B, a bipolar cell may include a separator 40 included as a coating on an anode 30 or anode active material. The coating may be layered on, optionally wholly on the surface of the anode opposite the surface of the anode that contacts the bipolar metal plate 10. In this way the separator allows the desired ion transport between the anode and the cathode during cycling of the cell, but also entirely separates the two so as to prevent shorts or undesirable self-discharge.

Optionally as illustrated in FIG. 3C, a separator 40 may be coated on both an anode 30 and a cathode 20. The separator may be partially or wholly coating either the anode, cathode or both, so long as there is separator material between the entire surface area of the smaller of the anode or cathode surface area. In this way the stacking of the materials allows for efficient separation and ion conduction between the anode and the cathode.

In other exemplary aspects as illustrated in FIG. 3D, an anode 30, cathode 20 or both may themselves be coated onto individual current collector substrates or bipolar metallic plates 10, 10′ depending on the desired location of the anode and cathode. The resulting coated bipolar metallic plate or current collector substrates may then be stacked and separated by a membrane or film of separator 40 as described herein so as to achieve a functional bipolar cell.

In yet other alternative aspects, a separator material 40 may be coated onto either an anode 30, cathode 20, or both whereby the anode active material, cathode active material or both may itself be coated onto a bipolar metallic plate 10 or current collector substrate.

In an exemplary aspect as illustrated in FIG. 3E, the anode active material 30 and cathode active material 20 are both coated onto individual bipolar metallic plates, 10, 10′. The separator material 40 is then coated onto the surface of the anode active material 30. While FIG. 3E illustrates coating on an anode active material, not shown, but contemplated on this disclosure is the coating of a separator onto a cathode active material. Alternatively, as illustrated in FIG. 3F, one or more of the same or different separator materials 40, 40′ may be coated onto both the anode active material 30, and cathode active material 20 such that stacking of the plates results in a bipolar cell structure.

Manufacturing of the coated bipolar metal plates or current collector substrates with an anode active material, cathode active material or both, typically involves coating the metal substrate with a layer of the electrode active material in the presence of a solvent. An exemplary solvent that is commonly used is N-Methyl-2-pyrrolidone (NMP). A binder, which by example only may be poly vinylidene fluoride (PVDF), may also be included. After the coating of the electrode material has been applied to the substrate, the coating may be dried such as by heating, subjecting to ambient atmosphere, subjected to microwave energy or other energy. The material may optionally be subjected to a calendaring process to press and heat the coating, which increases the density of the coating. Adhesion between a coating and a substrate is usually achieved through surface roughness, chemical bonding, and/or interface reaction or compound.

As described above, an anode, cathode or both may serve as a standalone membrane that may simply be layered onto the bipolar metallic plate or current collector substrate optionally as illustrated in FIGS. 3A-C. The anode active material, cathode active material membranes may be formed by combining the respective electrode active material with a solvent and a binder material and pressed, calendered, spayed onto a releasing surface or other and then dried so as to form the resulting membrane structure.

Alternatively, the respective electrode active material may be combined with a support substrate such as a cathode substrate or an anode substrate depending on whether an anode active material or cathode active material is being utilized in the particular structure. The presence of the support substrate allows for a more robust cathode or anode structure that may be individual stacked with the bipolar plate, current collector substrate, and separator for rapid manufacture. An exemplary substrate for an anode or a cathode is steel such as stainless steel, nickel-plated steel, aluminum optionally an aluminum alloy, nickel or nickel alloy, copper or copper alloys, polymers, glass, or other material that suitably may conduct or transmit desired ions and electrons, or other such material. The substrate(s) may be in the form of a sheet optionally as a foil, solid substrate, porous substrate, grid, foam or foam coated with one or more metals, perforated metallic material such as perforated nickel-plated stainless steel or the like, or other form. In some aspects, an anode substrate, cathode substrate or both is in the form of a foil. Optionally, a grid may include expanded metal grids and perforated foil grids. It is not necessary that an anode substrate, cathode substrate, or both be in direct contact with a bipolar metallic plate or current collector substrate, but may be housed within the respective electrode active material. In some aspects, however, an anode substrate, cathode substrate, or both are in electrical contact, optionally direct electrical contact with a bipolar metallic plate and/or current collector substrate.

An anode active material as used in a bipolar cell as provided herein optionally includes one or more hydrogen storage materials. An anode active material optionally includes SiₓM₁₋ₓ wherein M comprises one or more non-Si group 14 elements, a transition metal, a post-transition metal, or an alkaline or alkaline earth element as a dopant, and wherein 0<x<1. Illustrative examples of such materials are the ABₓ class of hydrogen storage materials where A is a hydride forming element, B is a non-hydride forming element and x is from 1-5. Illustrative examples include the AB, AB₂, AB₃, A₂B₇, A₅B₁₉, and AB₅ type materials as they are known in the art. A hydride forming metal component (A) optionally includes but is not limited to titanium, zirconium, vanadium, hafnium, lanthanum, cerium, praseodymium, neodymium, promethium, samarium, yttrium, or combinations thereof or other metal(s) such as a mischmetal. A B (non-hydride forming) component optionally includes a metal selected from the group of aluminum, chromium, manganese, iron, nickel, cobalt, copper, and tin, or combinations thereof. In some aspects, ABₓ type materials that may be further included in an anode electrochemically active material are disclosed, for example, in U.S. Pat. Nos. 5,536,591 and 6,210,498. Optionally, non-group 14 element containing hydrogen storage materials are as described in Young, et al., International Journal of Hydrogen Energy, 2014; 39 (36): 21489-21499 or Young, et al., Int. J. Hydrogen Energy, 2012; 37:9882. Optionally, anode active materials are as described in U.S. Patent Application Publication No: 2016/0118654. In some aspects, an anode active material includes hydroxides, oxides, or oxyhydroxides of Ni, Co, Al, Mn, or combinations thereof, optionally as described in U.S. Pat. No. 9,502,715. Optionally, an anode active material includes a transition metal such as Ti, V, Cr, Mn, Fe, Co, Ni, Cu, Zn, Ag, Au, Cd, or combinations thereof, optionally as disclosed in U.S. Pat. No. 9,859,531.

In some aspects, M in the formula SiₓM₁₋ₓ is optionally one or more group 14 elements. Group 14 elements include carbon (C), silicon (Si), germanium (Ge), tin (Sn), and lead (Pb). In some aspects, a group 14 element excludes Pb. Optionally, a group 14 element is C, Si, Ge, or any combination thereof. In some aspects, an anode electrochemically active material includes Si. Optionally, an anode electrochemically active material includes C. Optionally, an anode electrochemically active material includes Ge. Optionally M is C, Ge, or any combination thereof. Optionally, M is C. Optionally, M is Ge. Optionally, x is 0.5 or greater, optionally x is 0.55 or greater, optionally x is 0.6 or greater, optionally x is 0.65 or greater, optionally x is 0.7 or greater, optionally x is 0.71 or greater, optionally x is 0.72 or greater, optionally x is 0.73 or greater, optionally x is 0.74 or greater, optionally x is 0.75 or greater, optionally x is 0.76 or greater, optionally x is 0.77 or greater, optionally x is 0.78 or greater, optionally x is 0.79 or greater, optionally x is 0.8 or greater, optionally x is 0.85 or greater, optionally x is 9 or greater, optionally x is 0.95 or greater, optionally x is 0.96 or greater, optionally x is 0.97 or greater, optionally x is 0.98 or greater, or optionally x is 0.99 or greater.

The anode active material is presented in a powder form, meaning that the anode electrochemically active material is a solid at 25 degrees Celsius (° C.) and free of any substrate. The powder may be held together by a binder that associates the powder particles in a layer that is coated onto or into a substrate, a biopolar metallic plate, or a current collector substrate in the formation of an anode.

A bipolar cell as provided herein also includes a cathode that includes a cathode active material. A cathode active material has the capability to absorb and desorb a hydrogen ion in the cycling of a battery so that the cathode active material functions in pair with the anode active material to produce an electrical current. Illustrative materials suitable for use in a cathode active material include metal hydroxides. Illustrative examples of metal hydroxides that may be used in a cathode active material include those described in U.S. Pat. Nos. 5,348,822; 5,637,423; 5,366,831; 5,451,475; 5,455,125; 5,466,543; 5,498,403; 5,489,314; 5,506,070; 5,571,636; 6,177,213; and 6,228,535.

In some aspects, a cathode active material includes a hydroxide of Ni alone or in combination with one or more additional metals. Optionally, a cathode active material includes Ni and 1, 2, 3, 4, 5, 6, 7, 8, 9, or more additional metals. Optionally, a cathode active material include Ni as the sole metal.

Optionally, a cathode active material includes one or more metals selected from the group of Sc, Ti, V, Cr, Mn, Fe, Co, Ni, Cu, Zn, Y, Zr, Nb, Mo, Tc, Ru, Rh, Pd, Ag, Cd, Lu, Hf, Ta, W, Re, Os, Ir, Pt, Au, a hydride thereof, an oxide thereof, a hydroxide thereof, an oxyhydroxide thereof, or any combination of the foregoing. Optionally, a cathode active material includes one or more of Ni, Co, Mn, Zn, Al, Zr, Mo, Mn, a rare earth, or combinations thereof. In some aspects, a cathode active material includes Ni, Co, Al, or combinations thereof.

A cathode active material may include Ni. Ni is optionally present at an atomic percentage relative to the total metals in the cathode active material of 10 atomic percent (at %) or greater. Optionally, Ni is present at 15 at % or greater, optionally 20 at % or greater, optionally 25 at % or greater, optionally 30 at % or greater, optionally 35 at % or greater, optionally 40 at % or greater, optionally 45 at % or greater, optionally 50 at % or greater, optionally 55 at % or greater, optionally 60 at % or greater, optionally 65 at % or greater, optionally 70 at % or greater, optionally 75 at % or greater, optionally 80 at % or greater, optionally 85 at % or greater, optionally 90 at % or greater, optionally 91 at % or greater, optionally 92 at % or greater, optionally 93 at % or greater, optionally 94 at % or greater, optionally 95 at % or greater, optionally 96 at % or greater, optionally 97 at % or greater, optionally 98 at % or greater, optionally 99 at % or greater. Optionally the sole metal in the cathode electrochemically active material is Ni.

An anode active material, a cathode active material, or both are optionally in a powder or particulate form. The particles may be held together by a binder to form a layer on a current collector in the formation of the anode or cathode. A binder suitable for use in forming an anode, a cathode or both is optionally any binder known in the art suitable for such purposes and for the conduction of a proton.

Illustratively, a binder for use in the formation of an anode, a cathode, or both includes but is not limited to polymeric binder materials. Optionally a binder material is an elastomeric material, optionally styrene-butadiene (SB), styrene-butadiene-styrene block copolymer (SBS), styrene-isoprene-styrene block copolymer (SIS) and styrene-ethylene-butadiene-styrene block copolymer (SEBS). Illustrative specific examples of a binder include, but are not limited to polytetrfluoroethylene (PTFE), polyvinyl alcohol (PVA), teflonized acetylene black (TAB-2), styrene-butadiene binder materials, or/and carboxymethyl cellulose (CMC). Illustrative examples may be found in U.S. Pat. No. 10,522,827. The ratio of electrochemically active material to binder is optionally from 4:1 to 1:4. Optionally, the ratio of electrochemically active material to binder is 1:3 to 1:2.

A cathode, anode or both may further include one or more additives intermixed with the active materials. An additive is optionally a conductive material. A conductive material is optimally a conductive carbon. Illustrative examples of a conductive carbon include graphite. Other examples are materials that contain graphitic carbons, such as graphitized cokes. Still other examples of possible carbon materials include non-graphitic carbons that may be amorphous, non-crystalline, and disordered, such as petroleum cokes and carbon black. A conductive material is optionally present in an anode or a cathode at a weight percent (wt %) of 0.1 wt % to 20 wt %, or any value or range therebetween.

An anode or a cathode may be formed by any method known in the art. For example, an anode electrochemically active material or a cathode electrochemically active material may be combined with a binder, and optionally conductive material, in an appropriate solvent to form a slurry. The slurry may be coated onto a bipolar metal plate, current collector substrate or electrode support and dried to evaporate some or all of the solvent to thereby form an electrochemically active layer.

A cell of a bipolar battery as provided herein includes a bipolar metallic plate associated with the anode active material, the cathode active material, or both. On a first side of the bipolar metallic plate is an anode active material in electrical contact with the bipolar metallic plate, and on a second side of the bipolar metallic plate is a cathode active material in electrical contact with the bipolar metallic plate. The bipolar metallic plate may be made of any suitable electron conducting material. Optionally, a bipolar metallic plate is steel such as stainless steel, nickel-plated steel, aluminum optionally an aluminum alloy, nickel or nickel alloy, copper or copper alloys, polymers, glass, or other material that suitably may conduct or transmit desired electrons, or other such material. The bipolar metallic plate may be in the form of a sheet optionally as a foil, solid substrate, porous substrate, grid, foam or foam coated with one or more metals, or other form. In some aspects, bipolar metallic plate is in the form of a foil. Optionally, a grid may include expanded metal grids and perforated foil grids.

A bipolar battery as provided herein may be anode limited or cathode limited. Limited in the context of the cathode or anode is relative to the opposite electrode and may be limited in terms of capacity, surface area, or both. Optionally, a battery is cathode limited meaning that the capacity, surface area or both of the cathode is lower than the capacity of the anode. In some aspects, the ratio of the capacity of the cathode to the anode is less than 1, optionally at or less than 0.99, optionally at or less than 0.98, at or less than 0.97, at or less than 0.96, at or less than 0.95, at or less than 0.9, at or less than 0.85, or at or less than 0.8. Optionally, the ratio of the surface area of the cathode to the anode is less than 1, optionally at or less than 0.99, optionally at or less than 0.98, at or less than 0.97, at or less than 0.96, at or less than 0.95, at or less than 0.9, at or less than 0.85, or at or less than 0.8.

While in some aspects, a separator as provided herein may function as both a separator and electrolyte due to the ability of the separator to conduct a proton or hydroxide ion and provide the required electrical insulating characteristics to serve a separator between the anode and the cathode, it is appreciated that in some aspects a bipolar battery may further include a separate electrolyte, optionally a liquid or solid polymer electrolyte. An electrolyte may be impregnated into a separator, or may be adjacent to the separator on one or both sides between the separator and the adjacent electrode.

An electrolyte may be any proton or hydroxide ion conducting electrolyte. Optionally, an electrolyte is an alkali hydroxide including hydroxides of potassium, sodium, calcium, lithium, or any combination thereof. Specific non-limiting illustrative examples of electrolytes include KOH, NaOH, LiOH, Ca(OH) 2, among others, in any suitable concentration, optionally 20 to 45 weight percent in water.

In other aspects, an electrolyte is optionally solid polymer electrolyte. A solid polymer electrolyte may include a polymeric material such as poly(ethylene oxide), poly(vinyl alcohol), poly(acrylic acid), or a copolymer of epichlorohydrin and ethylene oxide, optionally with one or more hydroxides of potassium, sodium, calcium, lithium, or any combination thereof.

An electrolyte may optionally be or include one or more organic solutions. Illustrative examples of an organic electrolyte material include ethylene carbonate (EC), propylene carbonate (PC), dimethyl sulfoxide (DMSO), dimethylformamide (DMF), or polyvinyl alcohol (PVA) with added acid, proton conductive ionic liquids as known in the art. Illustrative examples of a proton conductive ionic liquids may include, but are not limited to those that include acetates, sulfonates, or borates of 1-butyl-3-methylimidazolium (BMIM), 1-ethyl-3-methylimidazolium (EMIM), 1,3-dimethylimdiazolium, 1-ethyl-3-methylimidazolium, 1,2,3-trimethylimidazolium, tris-(hydroxyethyl)methylammonium, 1,2,4-trimethylpyrazolium, or combinations thereof. Specific examples include diethylmethylammonium trifluoromethanesulfonate (DEMA TfO), 1-ethyl-3-methylimidazolium acetate (EMIM Ac) or 1-butyl-3-methylimidazolium bis(trifluoromethylsulfonyl)imide (BMIM TFSI).

The stack of cells are optionally flanked on each end by a current collector substrate. A current collector substrate may be formed of any material that has suitable conductivity to transmit electrons from an associate cell to an external environment. A current collector substrate may be formed of steel such as stainless steel, nickel-plated steel, aluminum optionally an aluminum alloy, nickel or nickel alloy, copper or copper alloys, or other such material. For an anti-corrosion property in acid electrolyte, a current collector substrate may be formed of stainless steel. Optionally, both the current collector substrates at an of the anode of a cell stack and the cathode end of the cell stack are formed of nickel plated stainless steel.

A current collector is optionally in the form of a sheet, and may be in the form of a foil, solid substrate, porous substrate, grid, foam or foam coated with one or more metals, or other form known in the art. In some aspects, a current collector is in the form of a foil. Optionally, a grid may include expanded metal grids and perforated foil grids.

The current collector or substrates may include one or more tabs to allow the transfer of electrons from the current collector to a region exterior of the cell and to connect the current collector(s) to a circuit so that the electrons produced during discharge of the cell may be used to power one or more devices. A tab may be formed of any suitable conductive material (e.g. Ni, Al, or other metal) and may be welded onto the current collector. Optionally, each electrode has a single tab.

The stack of cells in the bipolar battery may be housed in a cell case (e.g. housing). The housing may be in the form of a metal or polymeric can, or can be a laminate film, such as a heat-sealable aluminum foil, such as an aluminum coated polypropylene film. As such, a bipolar battery as provided herein may be in any known cell form, illustratively, a button cell, pouch cell, cylindrical cell, or other suitable configuration. In some aspects, a housing in is in the form of a flexible film, optionally a polypropylene film. Such housings are commonly used to form a pouch cell. The proton conducting battery may have any suitable configuration or shape, and may be cylindrical or prismatic.

A bipolar battery includes two or more cells whereby each cell is separated by a bipolar metallic plate and at each end of the stack exists a current collector substrate. A bipolar battery may have 2 or more cells, optionally 3 or more cells, optionally 4, 5, 6, 7, 8, 9, 10 or more cells in a stack arrangement.

The bipolar batteries as provided herein have unexpectedly high coulombic efficiencies. Coulombic efficiencies as provided herein may be measured as the discharge capacity in mAh at 100 mAh/g of anode active material plus the discharge capacity in mAh at 24 mAh/g anode active material, plus the discharge capacity in mAh at 8 mAh/g anode active material, all divided by the charge in. A coulombic efficiency of a bipolar battery as provided herein is optionally at or in excess of 70%, optionally 71%, optionally 72%, optionally 73%, optionally 74%, optionally 75%, optionally 79%, optionally 80%, optionally 81%, optionally 82%, optionally 83%, optionally 84%, optionally 85% where the columbic efficiency is the stabilized max coulombic efficiency of the battery.

Various aspects of the present disclosure are illustrated by the following non-limiting examples. The examples are for illustrative purposes and are not a limitation on any practice of the present invention. It will be understood that variations and modifications can be made without departing from the spirit and scope of the invention.

### EXPERIMENTAL

### Example 1

Test bipolar batteries were constructed using an anion exchange membrane as a standalone separator. The anode was a pasted electrode on a perforated Ni-plated stainless steel plate with superlattice metal hydride alloy as the active material with some binders. The cathode was a pasted electrode on a Ni-foam with Co-coated Ni(OH) 2 as the active material with some binders. The cell design was cathode limited. Anodes were 14×23×0.31 millimeters (mm) in overall dimension. Cathodes were 10×18×0.37 mm in overall dimension. An AEM8_25 anion exchange membrane from IONOMR, Vancouver, CA was used as a separator. The anodes, cathodes and separators were soaked in a KOH—NaOH—LiOH (3N-3N-0.4N) solution for 17 hours. After soaking, excess electrolyte was wiped off the surface and a bipolar cell was constructed by pairing an anode, separator, and cathode separated by nickel plates that serve as bipolar metallic plates and sandwiched between a Ni block current collector substrate at the anode end of the battery, and a Ni foam current collector substrate at the cathode end of the battery. Two batteries were made, one with 2 cells assembled in the overall bipolar battery stack, and a second battery with 5 cells assembled in the overall bipolar battery stack.

The batteries were cycled as follows: Charge—0.05C (14.45 mA/g per positive active material in each cell), 12 hour (hr) (state-of-charge 60%); 1 minute (min) rest; Discharge—0.05C (14.45 mA/g); 1 min rest; Discharge 0.025C (7.2 mA/g); 1 min rest; Discharge: 0.0125C (3.6 mA/g); 1 min rest; Discharge: 0.01C (2.9 mA/g) to a final cutoff voltage of 4 Volts (V) for the 5 cell stack or 1.6 V for the 2 cell stack. For these cells, 1C is equal to 289 mA/g calculated from a standard positive electrode of 289 mAh/g per active material weight.

The capacities in mAh/weight of cathode active material for the first 16 cycles of the 5 cell battery are illustrated in Table 1.

TABLE 1

| | | | | | | Coulomb |
|---|---|---|---|---|---|---|
| Cycle # | C/20 | C/40 | C/80 | C/100 | Total | efficiency |
| 1 | 130.6 | 1.0 | 1.0 | 0.5 | 133.1 | 76.7% |
| 2 | 152.7 | 0.8 | 0.9 | 0.8 | 155.2 | 89.5% |
| 3 | 156.7 | 0.4 | 1 | 0.9 | 159.0 | 91.7% |
| 4 | 158.1 | 0.4 | 0.9 | 0.8 | 160.2 | 92.4% |
| 5 | 159.1 | 0.4 | 0.9 | 0.8 | 161.2 | 93.0% |
| 6 | 160.0 | 0.7 | 1.2 | 0.6 | 162.5 | 93.7% |
| 7 | 160.7 | 0.6 | 2.4 | 0.6 | 164.3 | 94.8% |
| 8 | 162.3 | 0.4 | 0.8 | 0.7 | 164.2 | 94.7% |
| 9 | 163.2 | 0.4 | 0.8 | 0.7 | 165.1 | 95.2% |
| 10 | 163.6 | 0.4 | 0.8 | 0.8 | 165.6 | 95.5% |
| 11 | 163.8 | 0.4 | 1.7 | 0.7 | 166.6 | 96.0% |
| 12 | 163.5 | 0.4 | 1.4 | 1.0 | 166.3 | 95.9% |
| 13 | 163.5 | 1.0 | 2.0 | 0.7 | 167.2 | 96.4% |
| 14 | 163.3 | 1.3 | 1.4 | 0.6 | 166.6 | 96.1% |
| 15 | 163.5 | 1.8 | 1.5 | 0.6 | 167.4 | 96.5% |
| 16 | 163.4 | 1.5 | 2.3 | 0.6 | 167.8 | 96.8% |

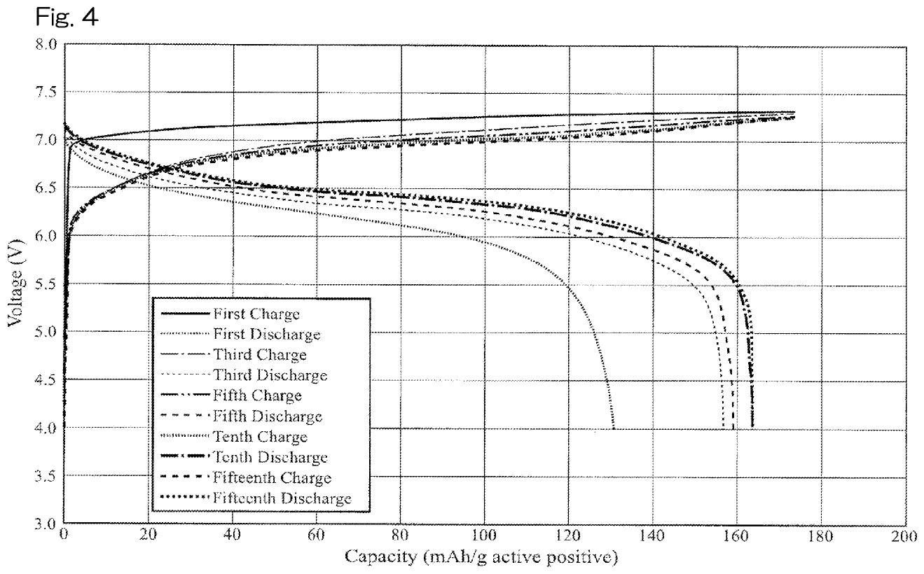

More than 97% of the discharge was from the highest discharge rate (C/20). The coulomb efficiency stabilizes at 96% after 10 cycles. The charge/discharge profile of selected cycles in the first 15 are plotted in FIG. 4. As is presented, the end-of-charge voltage is about 7.3 V, which is about five times of the usual end-of-charge of one single cell demonstrating excellent cell capacity and coulombic efficiency of the bipolar cells.

### Example 2

A second battery was constructed identical to the 2 cell battery of Example 1, with the exception that the AEM membrane was replaced with a porous polyolefin film (Shenzhen Highpower, Guangdong, China) soaked in anion exchange solution made from 2 milliliters (ml) ethanol and 0.04 grams (g) of anion exchange polymer (IONOMR, Vancouver, Canada) for 10 min. Following the soak the separator was dried in air for 1 hr. The electrodes and separator (17×27×0.015 mm) were soaked in the same electrolyte solution as in Example 1.

The battery was assembled as in Example 1 and cycled as per the Example 1 conditions. Results of the first twenty-five cycles are illustrated in Table 2.

TABLE 2

| | | | | | | Coulomb |
|---|---|---|---|---|---|---|
| Cycle # | C/20 | C/40 | C/80 | C/100 | Total | efficiency |
| 1 | 128.0 | 2.3 | 2.3 | 0.7 | 133.3 | 77.1% |
| 2 | 131.4 | 2.4 | 2.2 | 0.7 | 136.7 | 79.0% |
| 3 | 134.1 | 2.3 | 2.2 | 0.7 | 139.3 | 80.5% |
| 4 | 135.7 | 2.5 | 2.5 | 0.8 | 141.5 | 81.8% |
| 5 | 136.8 | 2.5 | 2.5 | 0.8 | 142.6 | 82.4% |
| 6 | 138.0 | 2.6 | 2.6 | 0.9 | 144.1 | 83.3% |
| 7 | 134.2 | 2.7 | 2.6 | 0.8 | 140.3 | 81.1% |
| 8 | 136.3 | 2.7 | 2.7 | 0.8 | 142.5 | 82.4% |
| 9 | 134.7 | 2.7 | 2.8 | 0.9 | 141.3 | 81.6% |
| 10 | 135.1 | 2.8 | 2.8 | 0.9 | 141.6 | 81.8% |
| 11 | 134.9 | 2.8 | 2.7 | 0.8 | 141.2 | 81.6% |
| 12 | 134.8 | 2.8 | 2.8 | 0.8 | 141.2 | 81.6% |
| 13 | 135.0 | 3.2 | 3.0 | 0.9 | 142.1 | 82.1% |
| 14 | 135.3 | 3.6 | 3.2 | 0.9 | 143.0 | 82.7% |
| 15 | 138.4 | 4.9 | 3.8 | 0.9 | 148.0 | 85.5% |
| 16 | 140.4 | 6.0 | 4.3 | 1.0 | 151.7 | 87.7% |
| 17 | 134.4 | 8.2 | 7.4 | 1.2 | 151.1 | 87.4% |
| 18 | 146.0 | 8.0 | 7.5 | 1.1 | 162.6 | 94.0% |
| 19 | 147.8 | 8.1 | 7.8 | 1.2 | 164.9 | 95.3% |
| 20 | 148.4 | 7.1 | 6.9 | 1.1 | 163.5 | 94.5% |
| 21 | 147.0 | 6.5 | 5.9 | 1.0 | 160.4 | 92.7% |
| 22 | 146.9 | 5.9 | 5.0 | 1.0 | 158.8 | 91.8% |
| 23 | 147.3 | 5.0 | 4.3 | 1.0 | 157.4 | 91.0% |
| 24 | 144.8 | 4.6 | 3.5 | 1.0 | 153.9 | 88.0% |
| 25 | 142.2 | 4.0 | 3.2 | 0.9 | 150.3 | 86.9% |

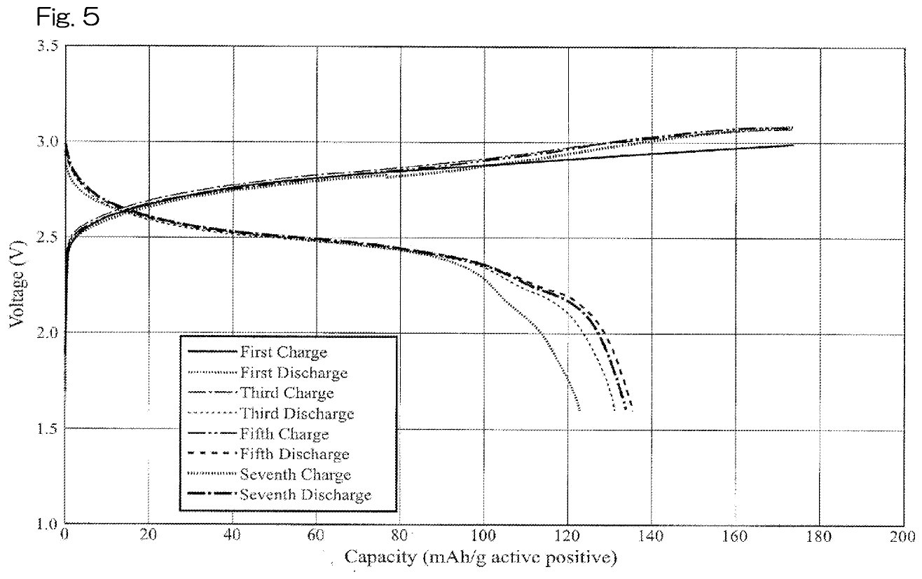

Similar to the battery of example 1, more than 95% of the discharge was from the highest discharge rate (C/20). The coulomb efficiency reaches a stable efficiency of greater than 90% after 17 cycles. The charge/discharge profile of selected cycles in the first 7 are plotted in FIG. 5. The end-of-charge voltage is about 3.0 V, which is about three times of the usual end-of-charge of one single cell demonstrating excellent cell capacity and coulombic efficiency of the bipolar cells.

The foregoing description of particular aspect(s) is merely exemplary in nature and is in no way intended to limit the scope of the invention as claimed below, its application, or uses, which may, of course, vary. The disclosure is provided with relation to the non-limiting definitions and terminology included herein. These definitions and terminology are not designed to function as a limitation on the scope or practice of the invention but are presented for illustrative and descriptive purposes only. While the processes or compositions are described as an order of individual steps or using specific materials, it is appreciated that steps or materials may be interchangeable such that the description of the invention may include multiple parts or steps arranged in many ways as is readily appreciated by one of skill in the art.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second (or other) element, component, region, layer, or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

Patents, publications, and applications mentioned in the specification are indicative of the levels of those skilled in the art to which the invention pertains. These patents, publications, and applications are incorporated herein by reference to the same extent as if each individual patent, publication, or application was specifically and individually incorporated herein by reference.

In view of the foregoing, it is to be understood that other modifications and variations of the present invention may be implemented. The foregoing drawings, discussion, and description are illustrative of some specific embodiments of the invention but are not meant to be limitations upon the practice thereof. It is the following claims, including all equivalents, which define the scope of the invention.

1. A bipolar battery comprising a stacked plurality of cells, two or more of said cells comprising:
a cathode containing cathode active material;
an anode containing anode active material, the anode active material comprising Ti, V, Cr, Mn, Co, Ni, Cu, Zn, Ag, Au, Cd, or combinations thereof;
a proton conducting polymer separator between said cathode and said anode;
a bipolar metallic plate associated with said anode or said cathode; and
an electrolyte comprising a solid polymer capable of conducting a proton.

2. The battery of claim 1, wherein said bipolar metallic plate is associated with said cathode and said anode.

3. The battery of claim 1, wherein said separator is in the form of a film, said film not bonded to either an anode or a cathode.

4. The battery of claim 1, wherein said separator is in the form of a coating on said anode, said cathode, or both.

5. The battery of claim 1, wherein said cathode is formed by pasting cathode active material on a cathode substrate, said anode is formed by pasting anode active material on an anode substrate, or both.

6. The battery of claim 5 wherein said cathode substrate, said anode substrate, or both comprises a Ni foil, optionally a porous Ni foil.

7. The battery of claim 1 wherein said separator selectively conducts a cation or an anion.

8. The battery of claim 7 wherein said separator selectively conducts an anion.

9. The battery of claim 7 wherein said anion is a hydroxide anion.

10. The battery of claim 7 wherein the ion conducting polymer comprises a hydroxide ion conducting membrane, optionally wherein said hydroxide ion conducting membrane comprises a support polymer coupled to an amine.

11. The battery of any one of claim 7 wherein said ion conducting polymer comprises a proton conducting membrane.

12. The battery of claim 11 wherein the proton conducting membrane comprises a perfluorinated polymer, optionally a perfluorosulfonic acid (PFSA) polymer.

13. The battery of claim 1 wherein said solid electrolyte is in the form of a membrane.

14. The battery of claim 7 wherein said ion conducting polymer is coated onto a solid ion conducting substrate.

15. The battery of claim 14, wherein said ion conducting substrate comprises Pt, Pd, LaNi₅, or an oxide optionally ZrO₂ or a perovskite oxide, or combinations thereof.

16. The battery of claim 7 wherein said ion conducting polymer is embedded in a porous substrate, optionally with a porosity measured as void volume to total volume of 40% or greater.

17. The battery of claim 16 further comprising a layer of proton or hydroxide ion conducting polymer on one or both sides of said porous substrate.

18. The battery of claim 7, wherein said at least a portion of said ion conducting polymer further comprises an ion conducting organic powder.

19. The battery of claim 1, the battery having a coulombic efficiency above 70%, optionally above 80%.

20. The battery of claim 1, wherein the anode active material comprises a hydrogen absorbing metal or metal alloy.

21. The battery of claim 20, wherein the metal alloy comprises a metal alloy of the ABₓ class of hydrogen storage materials where A is a hydride forming element, B is a non-hydride forming element and x is from 1-5.

22. The battery of claim 20, wherein the metal comprises SiₓM₁₋ₓ wherein M comprises one or more non-Si group 14 elements, and wherein 0<x≤1.

23. The battery of claim 1, wherein the cathode active material comprises Sc, Ti, V, Cr, Mn, Fe, Co, Ni, Cu, Zn, Y, Zr, Nb, Mo, Tc, Ru, Rh, Pd, Ag, Cd, Lu, Hf, Ta, W, Re, Os, Ir, Pt, Au, Bi, a hydride thereof, an oxide thereof, a hydroxide thereof, or an combination of the foregoing.

24. The battery of claim 23 wherein the cathode active material comprises Ni or Mn at greater than or equal to 10 atomic percent relative to all metals in the cathode electrochemically active material, optionally 80 atomic percent, optionally 90 atomic percent.

25. The battery of claim 23 wherein the cathode electrochemically active material comprises a hydroxide of Ni, Co, Mn, Zn, Al, or combinations thereof.

26. The battery of claim 23 wherein the cathode electrochemically active material comprises Ni.

27. A bipolar battery comprising a stacked plurality of cells, two or more of said cells comprising:
a cathode comprising a cathode active material capable of reversibly absorbing hydrogen, said cathode active material associated with a cathode substrate;
an anode comprising an anode active material capable of reversibly absorbing hydrogen, said anode active material associated with an anode substrate, the anode active material comprising Ti, V, Cr, Mn, Co, Ni, Cu, Zn, Ag, Au, Cd, or combinations thereof;
a proton conducting separator between said cathode and said anode, said separator configured to selectively allow transport of a proton, said separator configured as a film, as a component of a porous support membrane, or combinations thereof; and
a bipolar metallic plate associated with said anode or said cathode.

28. The battery of claim 27 wherein said separator selectively conducts an anion.

29. The battery of claim 27 wherein said anion is a hydroxide anion.

30. The battery of claim 27 wherein said ion conducting polymer comprises a proton conducting membrane.

31. The battery of claim 30 wherein the proton conducting membrane comprises a perfluorinated polymer, optionally a perfluorosulfonic acid (PFSA) polymer.

32. The battery of claim 27, wherein said separator further comprises one or more ion conducting inorganic powders.

33. The battery of claim 27 configured as cathode capacity limited.

34. The battery of claim 27, wherein said separator is in the form of a film, said film not bonded to either of said anode or said cathode.

35. The battery of claim 27, wherein said separator is in the form of a coating on said anode, said cathode, or both.

36. The battery of claim 27, wherein said cathode is made of cathode active material pasted on the cathode substrate, said anode is made of anode active material pasted on the anode substrate, or both.

37. The battery of claim 27, wherein said anode active material comprises SiₓM₁₋ₓ wherein M comprises one or more non-Si group 14 elements, and wherein 0<x≤1.

38. The battery of claim 27, wherein the cathode active material comprises oxide, hydroxide, oxyhydroxide of Ni or Mn at greater than or equal to 10 atomic percent relative to all metals in the cathode electrochemically active material, optionally at equal to or greater than 80 atomic percent, optionally 90 atomic percent.

39. The battery of claim 27, the battery having a stabilized coulombic efficiency above 70% after activation, optionally above 80%.
